(19) United States
(12) Patent Application Publication
(10) Pub. No.: US 2006/0291396 A1
(43) Pub. Date: Dec. 28, 2006

(54) Optimizing driving directions

(76) Inventors: Monplaisir Hamilton, Washington, DC (US); Anthony Whittington, Washington, DC (US)

Correspondence Address: ANTHONY WHITTINGTON AND M. HAMILTON, 1627 MASSACHUSETTS AVE. SE, WASHINGTON, DC, 20003, US

(21) Appl. No.: 11/166,734

(22) Filed: Jun. 27, 2005

(51) Int. Cl. H04J 1/16

(52) U.S. Cl. 370/238

(57) ABSTRACT

A method to render optimized driving direction to users that specify destinations of interest. The method utilizes a direction engine to generate a route to the destinations specified by the users. The directions engine receives requests including a plurality of options from the users. The options allow the user to select the type of routes that are favorable to the user and enables the direction engine to tailor the route according to the options selected by the user.

### CROSS-REFERENCE TO RELATED APPLICATION

Not applicable.

### STATEMENT REGARDING FEDERALLY SPONSORED RESEARCH OR DEVELOPMENT

Not applicable.

### FIELD OF THE INVENTION

Generally, the invention relates to the field of information retrieval. More specifically, the invention provides a method to generate optimized driving directions.

### BACKGROUND

Currently, travel planning tools provide techniques to receive information on routes from a specified point of origin to a specified destination. The tools provide static information on the routes between the point of origin and the specified destination.

For instance, a user wishing to travel from New York to Washington, D.C. may access a travel planning tool to generate a route from New York to Washington, D.C. The planning tool prompts the user for the point of origin, New York and the destination, Washington, D.C. The user responds to the prompts and initiates a route look-up to determine a suitable route from New York to Washington D.C. The travel planning tool returns a static route that list roads or highways that connect the point of origin to the destination. The routes are based on static information stored in a database provided by the travel planning tool.

Users feel more comfortable when traveling, if they have some control over how they are traveling to the destination. Due to exuberant gas prices, people want cost effective and optimal routes to travel to the destination. Currently, planning tools access static information when performing route look-ups and do not estimate gas consumption based on real-time data. Thus, a need arises to provide a user with a dynamic planning tool that provides a route matching a user's interest based on dynamic information and that generates a cost effective and optimal route to a specified destination.

### SUMMARY

A dynamic travel planning tool optimizes routes by utilizing criteria specifying a user's condition for a preferred route. The dynamic travel planning tool includes a direction engine, a graphical user interface and a database. The graphical user interface allows the user to specify the conditions for the preferred route, the direction engine processes the conditions to calculate the preferred route and the database stores dynamic information that allows the direction engine to optimize the preferred route.

Accordingly, the dynamic travel planning tools provides a system that optimizes a preferred route based on dynamic data and generates result that are consistent with a user's expectations. These and other advantages will become apparent to those skilled in the art upon examination of the following.

### BRIEF DESCRIPTION OF THE DRAWINGS

FIG. 1 illustrates a computing environment utilized by embodiments of the present invention;

FIG. 2 illustrates a block diagram of a dynamic travel planning tool utilized by embodiments of the present invention;

FIG. 3 illustrates a graphical user interface of the dynamic travel planning tool utilized by embodiments of the present invention; and

FIG. 4 illustrates a method to optimize route information generated by the dynamic traveling planning tool utilized by embodiments of the present invention.

### DETAILED DESCRIPTION

Embodiments of the present invention provide a dynamic travel planning tool having a receiving member to receive requests for a direct route specified by a user, wherein the requests include a toll and a plurality of other options, a direction engine to generate a route to a destination specified by the user, and an optimizer to optimize the route based on at least the toll option. Accordingly, the embodiments of the present invention provide a user with cost effective and optimal routes to the destination.

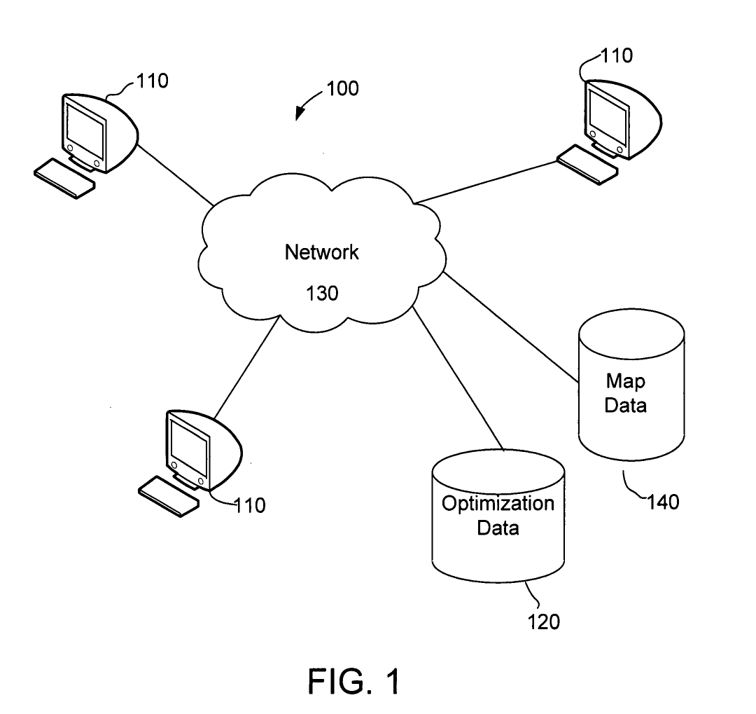

FIG. 1 illustrates a computing environment 100 utilized by embodiments of the present invention.

The computing environment 100 includes client devices 110 and server devices 120 and 140 and network 130. The client devices 110 are connected to the server devices 120 and 140 via the network 130.

The client devices 110 and server devices 120 and 140 may include processors, storage mediums, input devices, output devices, and device buses connecting the storage mediums and the input and output devices to the processors. The processors receive data from the input devices and transform the data to a suitable format to store on the storage mediums or to render on the output devices. The storage mediums may include non-volatile or volatile and removable or non-removable computer-readable mediums. The computer-readable mediums may include electronic storage devices, magnetic storage device, or carrier waves. The computer-readable medium may store instructions that enable the processor to execute application programs associated with the instructions. For instance, client devices 110 may store instructions to implement a dynamic travel planning tool, and the server devices 120 and 140 may include searchable devices, such as, for example databases that respond to requests generated by the dynamic travel planning tool. The input devices may include controllers, keyboards, mice, microphones, or any other suitable input devices. The output devices may include monitors, liquid crystal displays, projectors, or any other suitable output devices.

The network 130 provides a communication medium to allow client devices 110 and server devices 120 and 140 to transmit data structures that represent requests and responses. The network 130 may be a local area network, a wide area network, or the Internet, and the communication medium may be a wired or wireless medium.

The server devices 140 and 120 transmit a data structure representing a route to the client devices 110 in response to a request data structure generated by the client devices 110. The client devices 110 may include personal computers, laptops, mobile devices, or any other suitable computing device. The server device 140 may include a map database to store data corresponding to main roads, highways, and any other information found in a road, map, or atlas to assist a user traveling to a specified destination. The map data also includes information about landmarks, hotels or amusement venues located in regions represented on the map. The server device 120 may include optimization data, which includes real-time data that may modify the data stored on the server device 140. The real-time data collected and stored as optimization data may include traffic reports, weather information, gas price data, and price admission information to various venues located on the map. The server devices 120 and 140 communicate with each other to generate an optimal route in response the request data structure, which included an origin, user criteria and a destination. The computing environment 100 is an exemplary environment, and other configurations may be utilized with implementing embodiments of the present invention.

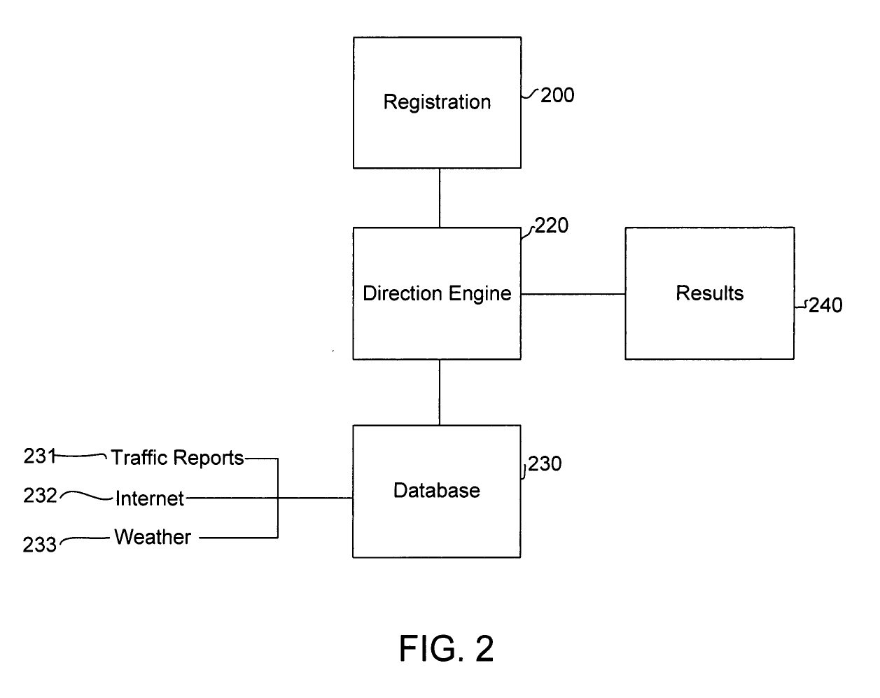

FIG. 2 illustrates a block diagram of a dynamic travel planning tool utilized by embodiments of the present invention. The client devices 110 may execute instructions for the dynamic travel planning tool.

The dynamic travel planning tool may include a registration unit 200, a direction engine 220, a database 230 and a rendering unit 240. The registration unit 200 receives data pertaining to the travel preferences in order to create profile for a user. The direction engine 220 generates a route to destinations specified by the user in response to the user's request. The database 230 stores route information and communicates with the direction engine 220 to initiate a search of the route information to respond the user's request. The route information is sent to the rendering unit 240 to output optimized routes.

The registration unit 200 allows the profile created by the user to be stored in the database 230 to enable the dynamic travel planning tool to match a user with their travel preferences. The user enters identification information and may utilize the profile to specify criteria for a route of interest. The travel preferences may be request options, such as, for example, a travel route having the most drug stores, hospitals, etc. Also, the registration unit allows the user to enter vehicle information, such as the make or model of the car. This enables the dynamic travel planning tool to estimate how far the user can travel on a tank and the number of tanks required to travel to the specified destination.

The direction engine 220 can be a processor that is capable of executing an algorithm that parses the received requests specified by the user to determine an optimized route. For instance, the optimized path algorithm can be Dijkstra' algorithm, Bellman-Ford algorithm, the mailman algorithm, or any algorithm suitable algorithm to generate a route based on specified metrics. The direction engine 220 is configurable to modify a request based on user feedback or to automatically modify a request based on rules or past user behavior, when the criteria specified create conflicting directions. The direction engine 220 is also configurable to consider traffic conditions along different routes to the specified destination. In an alternate embodiment of the present invention, the direction engine 220 may estimate a total cost to travel along a route. The cost may include fuel costs, venue costs, or rest costs.

The database 230 may include server devices 120 and 140 that store data corresponding to main roads, highways, and any other information found in a road or map atlas for assisting a user to travel to a specified destination. Furthermore, the database 230 communicates with the direction engine 220, which may be stored on the client or server devices 110-120 and 140, to generate optimized directions. The database 230 utilizes the Internet to receive real time information, such as, for example, traffic, weather information, gas prices, etc. Also, the database 230 may crawl the Internet to automatically update map data used to generate route information. The database 230 can also be programmed with map data content by a user or administrator. The map data content may include parameter values corresponding to, but not limited to, traffic reports 231, Internet sites 232, weather 233, or any type of data a user would like to consider in generating a set of optimized directions. The database 230 may search weather information specified in a farmer's almanac. Traffic report information may include past and current traffic reports. Accordingly, the database 230 is able to predict weather or congestion conditions along a route specified by the user.

The database 230 can be any device capable of storing data such as a ROM, recordable medium, memory, or the like. This list of storage devices is not exhaustive, but merely used for exemplary purposes. Furthermore, the database 230 may be used as a main or auxiliary storage means in association with the direction engine 220 for generating optimized directions.

The rendering unit 240 can act as a buffer or an interface to output the optimized routes to a display device. The rendering unit 240 provides the client device 110 with the optimized routes. Further, the rendering unit may act as a direct interface with the client device 110 to transmit messages between the client device 110 and the direct engine 220. In an embodiment of the present invention, the rendering unit 240 may include a comparison view to allow multiple routes to be displayed simultaneously.

Another embodiment of the dynamic travel planning tool is an optimizer to optimize the results of the database on at least the toll option and renders the optimized results. The optimizer includes a registration unit 200 for entering data by a user pertaining to the travel preferences in order to create profile; a direction engine 220 for generating a route to the destinations specified by the user in response to the received request processed by the receiving member; a database 230 for searching the received request processed by the receiving member in order to generate results illustrating directions to the generated route by the direction engine; a rendering unit 240 for outputting the optimized results. The optimizer further renders the optimized directions by a display means specifying an optimized route based on at least one of the request options. The results rendered by the optimizer is a direct route, which has the shortest distance to a specified location and the route has no tolls on the along it to the specified location. The optimizer is configurable to optimize the results using an at least one determined traffic condition along the route specified by the directions to the specified destination. The optimizer is also configurable to optimize the results based on at least one of the plurality of request options and the optimization algorithm.

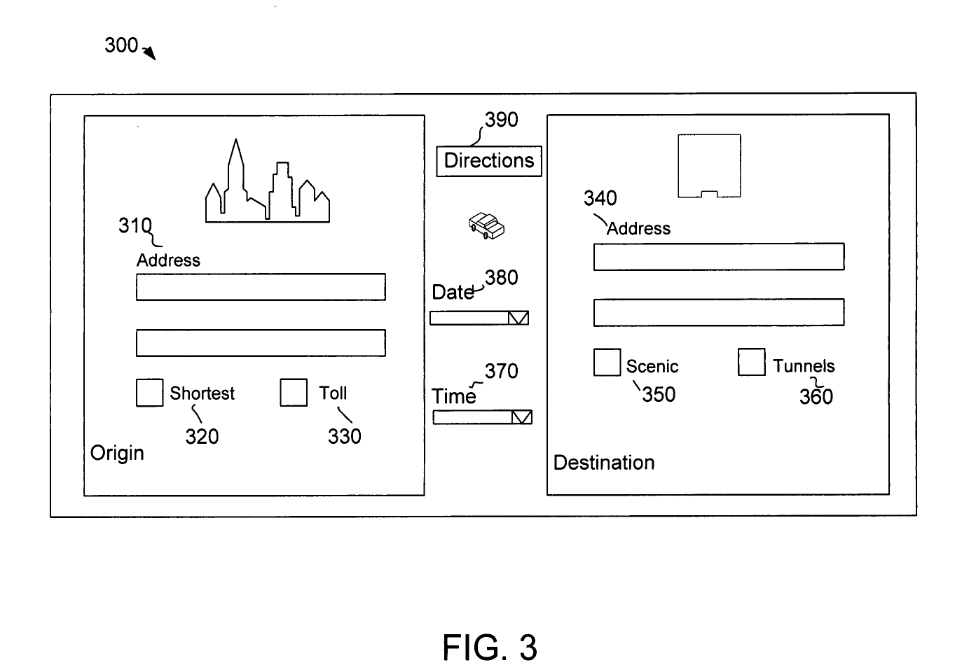

FIG. 3 illustrates a graphical user interface 300 of the dynamic travel planning tool utilized by embodiments of the present invention. The graphical user interface 300 allows the client devices 110 to enter an origin address 310 and a destination address 340. The graphical user interface 300 also includes option check boxes 320-330 and 350-360, and temporal information represented by a date dropdown box 380 and a time dropdown box 370, and a direction button 390 to initiate a route query utilizing the specified information.

When a client device 110 has registered with the dynamic travel planning tool, the graphical user interface 300 may automatically utilize information, stored in the profile of the client device 110, which corresponds to fields, options, or dropdown boxes included on the graphical user interface 300. The profile information may be stored on the client device 110 or on server devices 120 or 140.

The address fields 310 and 340 enable the client devices to specify the origin and destination of a user of the dynamic travel planning tool. This information is converted to points on a map and the appropriate metrics and algorithm are utilized to generate a route that matches the user's criteria. In an embodiment of the present invention, the criteria may include shortest route 320, a toll 330, scenic route 350, and tunnels 260. These criteria allow the user to shape the type of route generated by the dynamic travel planning tool. The temporal information, such as, for example, date 380 and time 370, enables the user to specify the time of departure. Additionally, in an embodiment of the present invention, a user may specify that the planning tool return the best time to travel to reach a destination in the quickest time possible. The dynamic travel planning tool utilizes the criteria as metrics for the algorithm to generate optimized route.

The information entered in the graphical user interface 300 may also include gas information that specifies the make and model pf the vehicle to allow the dynamic travel planning tool to return an estimate of gas expenditure along various routes returned to the user.

A client route query is processed by a receiving member, such as the direction engine, in order to generate results illustrating directions to the destination address 340. The routes generated are optimized utilizing the criteria specified in the route query, and rendered on the client device 110. The routes rendered may be a direct route, which has the shortest distance to the destination address 340 and no tolls. The dynamic travel planning tool is configurable to optimize the route using traffic conditions, temporal information, or gas usage information. In an embodiment of the present invention, some metrics may be related, for instance, a traffic metric is related to the gas usage metric, and should be combined when processed by the dynamic travel planning tool.

The client devices 110 generates route queries including request options, such as, for example, toll option 330, tunnel option 360, least traveled route option, dangerous conditions during inclement weather option, scenic option 350, shortest option 320, etc.

The toll option 330 allows the user to send the route query that generates an optimized route to the destination address 340 without encountering any tolls along the route. The tunnel option 350 is an option where a user can send the route query that generates an optimized route to the destination address 340 without encountering any tunnels. The least traveled path option, not shown, is an option where a user can send the route query that generates an optimized route to the destination address 340 by choosing a route is traveled least by the public or is less likely to have heavy traffic during rush hour to the destination address 340. The dangerous conditions during inclement weather option, not shown, is an option where a user can send the route query that generates an optimized route to a the destination address 340 that chooses a route with great road conditions during inclement weather such a ice storms, heavy rain, snow, or the like. In other words, the route selected is not eroded, not likely to flood, or not having severe potholes that can result in unsafe road conditions, especially in inclement weather. For instance, the route generated may be a route having salt applied on an hourly basis. The scenic option 350 is an option where a user can send the route query that generates an optimized route to the destination address 340, which provides the most scenery, famous landmarks, mountains, etc. along the route to the destination address 340. The shortest option 320 is an option where a user can send the route query that generates an optimized route to the destination address 340 that provides the shortest distance between the origin address 310 and the destination address 340 despite tolls, traffic, etc. along the path to the destination address 340. This list of query options is not exhaustive, but merely used for providing examples. In an embodiment of the present invention, the options may be combined in any reasonable manner, and if a request generates conflicting routes, one route is returned or all routes are rendered using the comparison view of the rendering unit 240.

Accordingly, the graphical user interface 300, allows a user to enter the origin address 310, to select from some of the request options, for example, shortest option 320, toll option 330, scenic option 350 or tunnel option 360 to retrieve optimized directions 390 to the destination address 340 specified by the estimated time 370 and date 380 of arrival. In an embodiment of the present invention, the user may enter the information by voice commands.

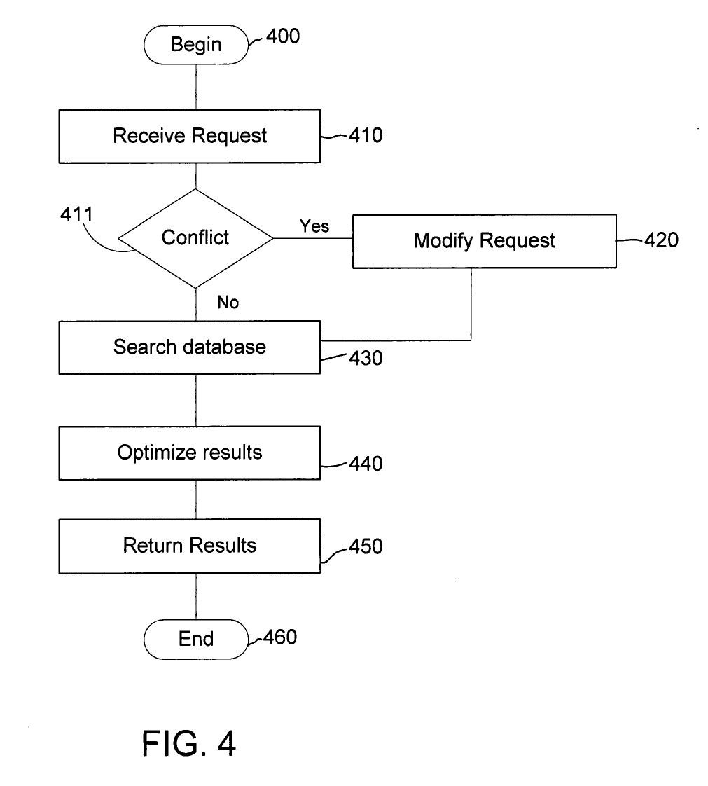

FIG. 4 illustrates a method to optimize route information generated by the dynamic traveling planning tool utilized by embodiments of the present invention.

The method begins, in step 400, after a user initiates the dynamic travel planning tool by sending a request to a receiving member, direction engine 220. Thereafter, registration unit 200 registers the user request and checks to see whether the user has a profile. If the user has a profile, the direction engine 220 generates a route using the destinations and criteria specified by the user's profile. Otherwise, the direction engine generates a route to the destinations specified by the user in response to the received request processed by the receiving member. As a result, the receiving member receives the request, which can include a toll option and a plurality of other options, in step 410. The direction engine initiates a conflict check, in step 411. In the event, the options selected create conflicting directions, the request may be modified by the direction engine 220, in step 420. Either the modified or original request is sent to the database 230, depending on the outcome of the conflict check, to generate routes illustrating directions to the d destination specified by the user, in step 430. At this point, results are optimized based on at least one of the request options and an optimization algorithm, in step 440. Lastly, the optimized results are returned via a display means to the user, in step 450, and the method ends, in step 460.

The display means is preferably a LCD display. However, the display means may be a CRT display, a flat screen television, computer monitor, or any device capable of displaying a visual image or data. This list of display means is not exhaustive, but merely used for providing examples. The display means can be substituted by a printing means for printing out the results of the optimized directions. Alternatively, the display means can be substituted by a voice output means such as a speaker to verbally convey the results of the optimized directions to a user.

Another embodiment of the method of operating the invention, shown in FIG. 4, comprises: sending a request; receiving requests including a toll and a plurality of request options; generating a route to a destination; searching a database to generate results illustrating directions to the specified destination; optimizing the results based on at least the toll option; and rendering the results optimized results.

Therefore, embodiments of the present invention provide a dynamic travel planning tool that generates a data structure representing optimized routes. The routes are optimized based on profile information and criteria information that allow the user to specify metrics such as time and gas prices. The dynamic travel planning tool provides data regarding best time of travel and landmark information to enable the user to efficiently plan a trip to a destination of interest. The foregoing descriptions of the invention are illustrative, and modifications in configuration and implementation will occur to persons skilled in the art. For instance, while the present invention has generally been described with relation to FIGS. 1-4, those descriptions are exemplary. The scope of the invention is accordingly intended to be limited only by the following claims.

We claim:

1. A method to retrieve optimized directions to a specified destination, the method comprising:
receiving requests including a toll option and a plurality of request options;
searching a database to generate results illustrating directions to the specified destination;
optimizing the results based on at least the toll option; and
rendering the results optimized results.

2. The method according to claim 1, wherein the plurality of request options include at least one of a scenic, shortest or tunnel options.

3. The method according to claim 1, further comprising:
automatically modifying the request when the options selected create conflicting directions.

4. The method according to claim 1, further comprising:
modifying the request based on user feedback.

5. The method according to claim 1, wherein optimizing the results includes determining the traffic conditions along the route specified by the directions to the specified destination.

6. A device for retrieving optimized directions to a specified destination comprising:
a receiving member to receive requests to find a direct route specified by a user, wherein a received request includes a toll option and a plurality of request options;
a direction engine to generate a route to the destinations specified by the user in response to the received request processed by the receiving member;
a database to search the received request processed by the receiving member in order to generate results illustrating directions to the generated route by the direction engine; and
an optimizer to optimize the results of the database on at least the toll option and rendering the optimized results.

7. The device according to claim 6, wherein the plurality of request options include at least one of a scenic, shortest or tunnel options.

8. The device according to claim 6, wherein the receiving member automatically modifies the request when the options selected create conflicting directions.

9. The device according to claim 6, wherein the receiving member modifies the request based on user feedback.

10. The device according to claim 6, wherein the optimizer optimizes the results using an at least one determined traffic condition along the route specified by the directions to the specified destination.

11. The device according to claim 6, wherein the database is configurable to retrieve toll information from the Internet.

12. The device according to claim 6, wherein the optimizer renders results of the direct route, the direct route having the shortest distance to a specified location and having no tolls on the direct route to the specified location.

13. An optimized directions retrieving system, the system comprising:
a receiving member to receive requests to find a direct route specified by a user, wherein a received request includes a toll option and a plurality of request options;
a direction engine to generate a route to the destinations specified by the user in response to the received request processed by the receiving member;
a database to search the received request processed by the receiving member in order to generate results illustrating directions to the generated route by the direction engine; and
an optimizer to optimize the results of the database on at least the toll option and rendering the optimized results.

14. The system according to claim 13, wherein the plurality of request options include at least one of a scenic, shortest or tunnel options.

15. The system according to claim 13, wherein the receiving member automatically modifies the request when the options selected create conflicting directions.

16. The system according to claim 13, wherein the receiving member modifies the request based on user feedback.

17. The system according to claim 13, wherein the optimizer optimizes the results using an at least one determined traffic condition along the route specified by the directions to the specified destination.

18. The system according to claim 13, wherein the database is configurable to retrieve toll information from the Internet.

19. The system according to claim 13, wherein the optimizer renders results of the direct route, the direct route having the shortest distance to a specified location and having no tolls on the direct route to the specified location.

20. The system according to claim 13, wherein the request is a data structure processed by the optimizer to render routes that match the request options.
